(19) United States
(12) Patent Application Publication
(10) Pub. No.: US 2020/0260176 A1
(43) Pub. Date: Aug. 13, 2020

(54) HEARING DEVICE CHARGER WITH INSERTION/EJECTION CONTROL

(71) Applicant: Sonova AG, Staefa (CH)

(72) Inventors: Christian Baltensperger, Männedorf (CH); Stefan Launer, Zurich (CH)

(21) Appl. No.: 16/637,785

(22) PCT Filed: Aug. 24, 2017
(86) PCT No.: PCT/EP2017/071325

§ 371 Date: Feb. 10, 2020

(51) Int. Cl. H04R 1/10; H04R 25/00

(52) U.S. Cl. CPC H04R 1/1025; H04R 2225/33; H04R 2225/31; H04R 25/556

(57) ABSTRACT

A charger for a hearing device that provides a user with control of insertion and/or ejection of the hearing device into or out of the charger. A user may use a user control to move the hearing device in the charger from a position where the hearing device can be charged by the charger and a removal position where the user may easily, manually remove the hearing device from the charger.

### BACKGROUND

Embodiments of the present disclosure provide a hearing device charger comprising a mechanism for inserting and/or ejecting a hearing device into/from the hearing device charger.

Hearing devices are often fitted with rechargeable batteries and may be recharged either using wireless charging or direct charging of the rechargeable batteries using charging terminals, while the batteries are still in the hearing device. For effective charging of the hearing device, either wirelessly of by providing a charging current to the hearing device, the hearing device may be held in a charging position in the hearing device charger.

U.S. Pat. No. 8,253,377 (the '377 patent’) describes a hearing aid battery charger for a hearing aid equipped with rechargeable batteries. In the '377 patent, the hearing aid is held in a charging position in the hearing aid battery charger while a charging current is provided to the hearing aid batteries. The '377 patent discloses charging the rechargeable batteries while the batteries are still disposed in the hearing aid.

### SUMMARY

In embodiments of the present disclosure, a hearing device charger is provided with insertion/ejection control. In some embodiments, the hearing device comprises a rechargeable battery that is configured to be recharged by a charging current provided by the charger via electrical contacts. In some embodiments, the charger and the hearing device comprise induction coils or the like to provide for wireless charging of the hearing device.

In embodiments of the present disclosure, the charging device comprises a user control configured to receive an input from a user to either insert the hearing device into the charger or to eject the hearing device from the charger and a mechanism that can insert and/or eject the hearing device from the charger in response to the user input.

In some embodiments, the hearing device is held in the charger to provide for electrical communication of a charging current supplied by the charger to the hearing device. In some embodiments, the charger is configured so that when the hearing device is inserted in the charger, an induction coil in the hearing device is aligned with an induction coil in the charger to provide for wireless charging.

In some embodiments of the present disclosure, the hearing device is ejected from the charger to provide that a user can grasp the hearing device. In some embodiments, the hearing device is completely ejected from a hearing dock of the charger. In some embodiments, after ejection from the charger, a longitudinal length of the hearing device extends beyond a top of the hearing dock such that a user can grasp the hearing device with their fingers to remove it from the charger.

These and further objects, features and advantages of the present invention will become apparent from the following description when taken in connection with the accompanying drawings which, for purposes of illustration only, show several embodiments in accordance with the present disclosure.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a charger for charging a re-chargeable ear worn communication device comprising a cradle configured for inserting and/or ejecting the ear worn communication device from the charger, in accordance with some embodiments of the present disclosure.

FIG. 2 illustrates a hearing device charger comprising a cradle configured to insert a re-chargeable ear worn communication device into the charger and/or eject the re-chargeable ear worn communication device from the charger using a mechanical mechanism, in accordance with some embodiments of the present disclosure.

FIG. 3 illustrates a system for inserting a re-chargeable ear worn communication device into and/or ejecting a re-chargeable ear worn communication device from a charger, in accordance with an embodiment of the present disclosure.

FIG. 4 illustrates a mechanically controlled system for inserting/ejecting a re-chargeable ear worn communication device from a charging dock, in accordance with some embodiments of the present disclosure.

FIG. 5 is a flow-type illustration of a method for inserting and/or ejecting a re-chargeable ear worn communication device into/out of a charger, in accordance with some embodiments of the present disclosure.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded or transmitted via any suitable means including memory sharing, message passing, token passing, network transmission, etc.

The phrases “in some implementations,” “according to some implementations,” “in the implementations shown,” “in other implementations,” and generally mean the particular feature, structure, or characteristic following the phrase is included in at least one implementation of the disclosed technology, and may be included in more than one implementation. In addition, such phrases do not necessarily refer to the same embodiments or different implementations.

Reference will now be made in detail to embodiments, examples of which are illustrated in the accompanying drawings and figures. In the following detailed description, numerous specific details are set forth in order to provide a thorough understanding of the subject matter herein. However, it will be apparent to one of ordinary skill in the art that the subject matter may be practiced without these specific details. In other instances, well known methods, procedures, components, and systems have not been described in detail so as not to unnecessarily obscure features of the embodiments. In the following description, it should be understood that features of one embodiment may be used in combination with features from another embodiment where the features of the different embodiment are not incompatible.

Hearing devices include hearing instruments—such as behind-the-ear hearing aids, in-the-ear hearing aids etc.—earphones, in-ear headphones, noise protection systems worn on/in the ear that include a speaker, and/or the like.

Many hearing devices are configured to be rechargeable to avoid the inefficient and problematic issue of replacing batteries. Moreover, charging systems are often designed to charge the rechargeable batteries in-situ, e.g., while installed in the hearing device. For example, the '377 patent describes systems and methods for charging a hearing aid in a charger without removing the hearing aid's rechargeable batteries.

Hearing devices, especially hearing devices equipped with rechargeable batteries, are being designed to smaller scales to make the instruments less bulky and to provide that the instruments can be comfortably and unobtrusively positioned in and/or proximal to the ear. Hearing device designs often comprise miniaturized systems that are almost invisible on the wearer.

Wireless/Bluetooth technology means that the earpiece of the hearing device may be miniaturized and wireless/Bluetooth signals may be transmitted to the miniature earpiece for delivery to the ear. Further, hearing devices are being made of materials, such as metal, polymers and/or the like, that increase the durability and/or wear resistance of the instrument and/or make the hearing device cosmetically appealing.

The smaller size of hearing devices and/or the properties of the new fabrication materials often make the hearing devices difficult to handle. This is especially true when it comes to a user inserting or removing the hearing device from a charger, where the hearing device needs to be positioned inside a charging dock in a charging position for effective charging. The insertion/removing problem is further compounded because, in general, chargers include a mechanism to hold hearing devices in the charging position in the charger. For example: for wireless chargers, for effective charging, an induction coil in the hearing device needs to be aligned with an induction coil in the wireless charger; and for wired charging, charging terminals on the hearing device need to be contacted with/held in contact with charging terminals in the charger/charging dock.

Mechanisms for holding hearing devices in a charging position may be mechanical and require the user to apply a force to insert and/or remove the hearing device from the holding mechanism. Moreover, a significant problem with insertion/removal of hearing devices from chargers by a user of the hearing device is the use by the user of cables/conduits or the like extending from the hearing device. Such use of the cables/conduits, especially when repeated, can cause serious damage to the hearing devices. Often the cables/conduits extending from the hearing device are some of the most fragile components of the hearing device.

For example, many in-ear communication devices include a wire(s) connecting outer-ear and in-ear parts of the hearing device and many hearing devices, such as for example behind-the-ear hearing instruments, include a sound delivery system that communicates sound detected by a microphone situated external to the ear into the inner-ear, both of which, the wire—especially at the connection point with the earphone—and/or the sound delivery system may be easily damaged by being used by a user to insert/eject the hearing device into/from the charger.

Embodiments of the present disclosure provide a charger for a hearing device comprising a user control and an insertion and/or an ejection mechanism for inserting the hearing device into and/or ejecting the hearing device out of the charger. More particularly, but not by way of limitation, some embodiments of the present disclosure provide for insertion of the hearing device into the charger and into a charging position and/or ejection of the hearing device from the charging position out of the charging device/to a removal position in the charging device, without the user applying a force or applying only a minimal force to the hearing device.

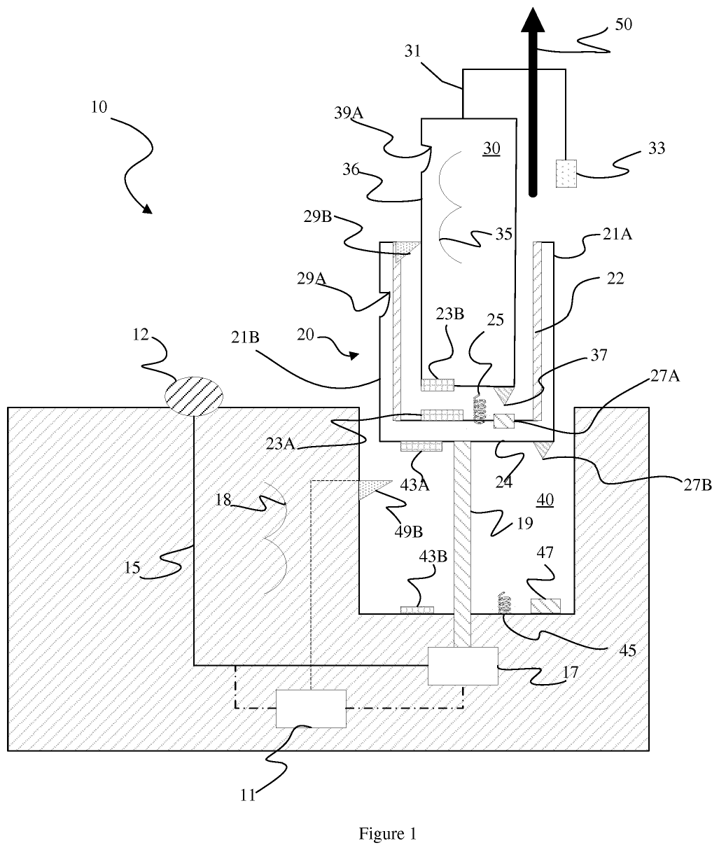

FIG. 1 illustrates a hearing device charger comprising a cradle configured to insert a hearing device into the charger and/or eject the hearing device from the charger, in accordance with some embodiments of the present disclosure.

In FIG. 1, a charger 10 comprises a cradle 20. The cradle 20 is configured to receive a hearing device 30. The hearing device 30 comprises batteries (not shown) or the like that provide for powering operation of the hearing device when worn by a user. The batteries are drained as a result of operation of the hearing device 30 and may be recharged by the charger 10.

The hearing device 30 may comprise a communication component 31, for example an electronic cable, an electronic cable attached to a speaker for in-ear operation, a sound tube and/or the like, that extends from the hearing device 30. The communication component 31 may in some aspects be configured in use to deliver sound from the hearing device 30 to a user's ear. In other aspects, the hearing device 30 may be configured to be worn in the ear and the communication component 31 may provide communication outside of the ear, such as via an antenna, communication device, wireless communication receiver, microphone and/or the like.

In some embodiments, the hearing device 30 may comprise an in-ear component 33, such as an ear-tip, speaker and/or the like, which in some embodiments may provide sound output in the inner-ear. Where the hearing device 30 is configured to be worn behind a user's ear (a behind-the-ear “BTE” hearing device), the communication component 31 and/or the in-ear component 33, which in combination may comprise a sound delivery system 31, 33, may comprise a sound tube, ear hook, electric cable, ear-tip, speaker and/or the like that is configured to deliver sound from the hearing device into the user's ear.

In certain embodiments, the cradle 20 is configured to insert the hearing device 30 to a charging position in the charger 10. For example, for wireless charging, the cradle 20 may move the hearing device 30 to a position in the charger 10 where a wireless induction coil 35 in the hearing device is aligned with a wireless induction coil 18 in the charger 10. In some embodiments, the charger 10 and/or the cradle 20 may comprise a holding mechanism for holding the hearing device 30 in the charging position in the charger 10. Similarly, after charging, the cradle 20 can be configured to eject the hearing device 30 from the charging position to an ejected position in the charger 10; where the hearing device 30 is accessible to the user for removal from the cradle 20 with little or no force and/or for grasping by the user by a body/housing of the hearing device 30.

For charging of the rechargeable batteries using a charging current, the cradle 20 may comprise a first terminal 27A that is configured to contact a charging terminal 37 of the hearing device 30. The cradle 20 may be configured to accommodate the hearing device 30, such that when the hearing device 30 is inserted into the cradle 20, the charging terminal 37 contacts the first terminal 27A providing for electrical communication between the charging terminal 37 and the first terminal 27A.

While the following description describes inserting/holding the hearing device 30 in the charger 10 to provide for use of a charging current, it is to be understood that the insertion/holding techniques/systems can also apply to insertion/holding the hearing device 30 in the charger 30 in a charging position for wireless charging.

In some embodiments of the present disclosure, the cradle 20 is shaped to provide that the hearing device can only be inserted into the cradle 20 in a single orientation, and this single orientation is configured to provide that the charging terminal 37 contacts the first terminal 27A when the hearing device 30 is inserted into the cradle 20.

In some embodiments, the cradle 20 is configured to provide that in excess of 50% of a longitudinal length of the hearing device 30 extends beyond walls 21A, 21B of the cradle 20 when the hearing device 30 is inserted into the cradle 20. The longitudinal length of the hearing device 30 comprises a length of the hearing device 30 aligned with a longitudinal axis 50 of the charging dock 40. Preferably, in some embodiments greater than 60%, 70% or 80% of the longitudinal length of the hearing device 30 extends beyond the walls 21A, 21B of the cradle 20 when the hearing device 30 is inside the cradle 20 with the charging terminal 37 in contact with/held in contact with the first terminal 27A. Having this amount of the hearing device 30 extends beyond the walls 21A, 21B of the cradle 20 provide for ease of handling of the hearing device 30 by a user of the hearing device 30. It has been found that where a large surface area of the housing 36 of the hearing device 30 is accessible to a user, the user will grip the hearing device 30 by the housing 36 of the hearing device 30 to insert/remove the hearing device 30 from the cradle 20, rather than using the communication component 31.

The cradle 20 may be shaped to provide that there is space between an outer-surface 36 of the hearing device 30 and an inner-surface 22 of the cradle 20. In such embodiments, gravity may provide for holding the charging terminal 37 and the first terminal 27A in contact. In some embodiments, magnets 23A and 23B may be used to hold the hearing device 30 in the cradle so that the charging terminal 37 and the first terminal 27A are held in contact. In some embodiments, one of the magnets 23A and 23B may not be a magnet but comprise a metallic compound to provide for the magnetic coupling. In this way, using only one magnet, the magnetic coupling force is reduced lessening the force needed to remove the hearing device 30 from the cradle 20. In some embodiments, the inner-surface 22 and or the outer-surface 36 may comprise an elastic and/or grippy/adhesive material that may hold the hearing device 30 in the cradle 20 after insertion by a user.

In some embodiments, a latch system may be used to hold the hearing device 30 in the cradle 20 such that the charging terminal 37 and the first terminal 27A are held in contact. The latch system may comprise a notch 39A or the like in the hearing device 30 and a nose 29B extending from the inner-surface 22 of the cradle. In some embodiments, the notch 39A may be a notch in the inner-surface 22 of the cradle and the nose 29B may extend from the outer-surface 36 of the hearing device 30. When the hearing device 30 is inserted into the cradle 20, such that the notch 39A and the nose 29B align, the notch 39A and the nose 29B interact to hold the hearing device 30 in the cradle 20 so that charging terminal 37 and the first terminal 27A are in contact.

In some embodiments, the charger 10 comprises a user input 12. The user input 12 may comprise an electrical switch or the like such that a user input may be electronically conveyed via electrical communicator 15 to an electrical actuator 17. The electrical actuator 17 may comprise a motor, a pump and/or the like and may interact with the cradle 20 via an interaction element 19. As such, in some embodiments of the present disclosure, the electrical actuator 17 receives communication of a user input to the user input 12 and generates motion of the cradle 20 into or out of the charger 10 via the interaction element 19. The interaction element 19 may in some embodiments comprise a screw-type mechanism a geared mechanism, a combination of coupled substrates, a hydraulic system and/or the like that is configured to translate an output from the electrical actuator 17 into motion of the cradle 20 into or out of the charger 10. In some embodiments of the present disclosure, the user input 12, the electrical communicator 15, the electrical actuator 17 and the interaction element 19 provide insertion/ejection of the hearing device 30 into/from the charger 10.

In some embodiments, the user input 12 may comprise an electrical switch or the like that can control the electrical actuator 17 to either insert the cradle 20 into the charger 10 or to eject the cradle 20 from the charger 10. In some embodiments, the user input 12 may comprise two separate inputs, one to control insertion of the cradle 20 and one to control ejection of the cradle 20. In some embodiments, the user input 12 may include a light or the like to identify the user input 12 to a user and/or to identify a status of the cradle 20, e.g., whether the cradle is inserted, ejected and/or whether the hearing device 30 is being charged/is fully charged.

In some embodiments, a controller 11 or the like may control the operation of the electrical actuator 17. The controller 11 may comprise processing circuitry that controls the operation of the electrical actuator 17 based upon a user's input.

The controller 11 may, in some embodiments, control the latch system such that when a user input is received by the controller 11 to insert the hearing device 30 in the charger 10, the controller 11 may control the latch system such that the latch, nose 29B or the like, is activated to position and/or hold the hearing device 30 in the cradle 20. Similarly, when a user input is received by the controller 11 to eject the hearing device 30 from the charger 10, the controller 11 may control the latch system such that the latch, nose 29B or the like, is retracted.

In some embodiments, an elastic element 25, such as a spring or the like, may be used to assist or provide for ejection of the hearing device 30 from the cradle 20. For example, if a user applied a force to the hearing device 30 to remove the hearing device 30 from the cradle 20, a force generated in response to compression of the elastic element 25 will assist the user's force. In some embodiments using a latch system, where the latch system is deactivated or its holding force is overcome, the elastic element 25 may at least partially eject the hearing device 30 from the cradle 20.

In some embodiments, the electrical actuator 17 is configured to move the cradle 20 into and out of a charging dock 40 in the charger 10 that is configured to accommodate the cradle 20. Like the cradle 20, the charging dock 40 may comprise: a magnet 43B for interacting with a magnet 43A on the cradle 20; a nose 49B or the like for coupling with a notch 29A or the like on the cradle to provide a latch system; an elastic element 45 to assist in removing the cradle 20 from the charging dock 40; an electrical terminal 47 for contacting with an electrical terminal 27B on the cradle 20, which is in conductive communication with the first terminal 27A; and a magnet 43B for interacting with a magnet 43A on the cradle 20 and holding the electrical terminal 47 in contact with electrical terminal 27B.

In some embodiments, the walls 21A, 21B may be moveably attached to a base of the cradle 24. For example, the walls 21A, 21B may be attached by a hinge to the base 24, may be attached so that the walls 21A, 21B may translate over the base 24 and/or the like. In such embodiments, when the cradle 20 is moved into or out of the charging dock 40, the walls 21A, 21B may be configured to move with respect to the base 24. For example, in some embodiments, the walls 21A, 21B may be configured to move inwards with respect to the base 24 and in so doing ‘grip’ the hearing device 30 as the hearing device 30 is inserted into the charging dock 40. This gripping of the hearing device 30 may be achieved by a transducer moving the walls 21A, 21B, by a spring loaded mechanism where interior walls of the charging dock 40 ‘push’ the walls 21A, 21B inwards, by contact between the walls 21A, 21B of the cradle 20 and the charging dock 40, and/or the like. Conversely, when the cradle 20 is ejected from the charging dock 40, the walls 21A, 21B may move outward relative to the base 24 releasing the hearing device 30. In such embodiments, there may be no retaining force being applied to the hearing device 30 when the cradle 20 is in an ejected position for a user to overcome when removing the hearing device 30 from the cradle 20. Moreover, access to the hearing device 30 may be improved.

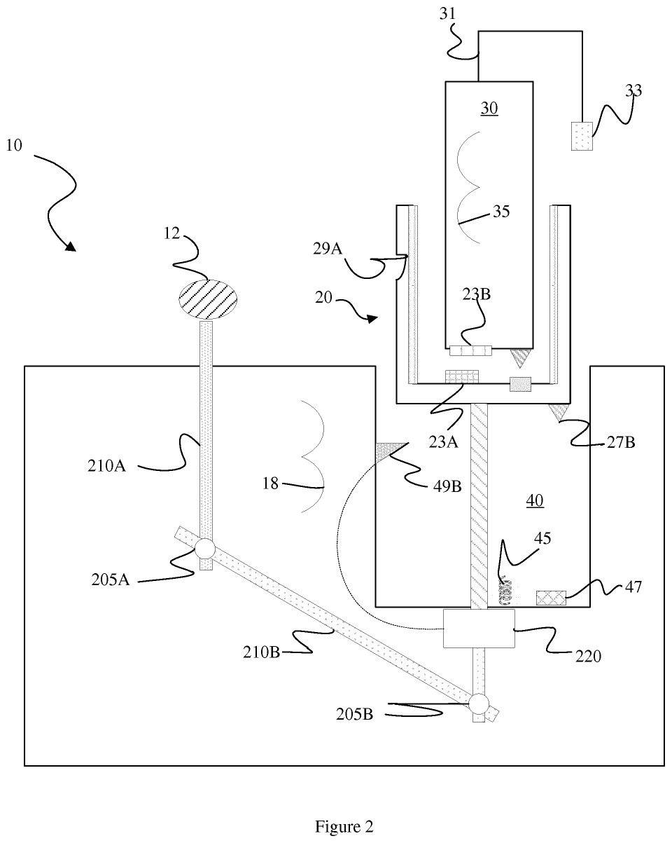

FIG. 2 illustrates a hearing device charger comprising a cradle configured to insert an hearing device instrument into the charger and/or eject the hearing device from the charger with a mechanical input, in accordance with some embodiments of the present disclosure.

As described with respect to FIG. 1, the cradle 20 may be used to insert/eject the hearing device 30 from the charger 10. In some embodiments, the user input 12 may comprise a switch, a button, a lever or a lid moveably coupled to the charger. The lid (not shown) may comprise a hinged lid or the like that covers the charging dock 40. In some embodiments, the user input 12 is configured to translate a user input force—e.g., a force that moves the switch, the button, the lever or the lid—to a mechanical insertion/ejection system.

For example, in some embodiments, the user input 12 may be coupled with a first lever 210A that is in turn coupled to a second lever 210B. The first lever 201A may be coupled with a pivot point 205A, which may comprise an axle, a gear and/or the like, such that movement of the first lever 210A causes the second lever to pivot around the pivot point 205A. The coupling of the first and second levers 210A & B is configured to provide for translating a direction of the force applied by the user to the user input 12. The second lever 210B is coupled in turn with an insertion/ejection mechanism 220. The second lever 210B may be coupled with the insertion/ejection mechanism 220 and may pivot around a pivot point 205B, which may comprise an axle, a gear and/or the like. The coupling of the second levers 210B and the insertion/ejection mechanism 220 is configured to provide for translating a direction of the force acting on the second lever 210B, such that the insertion/ejection mechanism 220 moves in a longitudinal direction in the charging dock 40.

In some embodiments, the insertion/ejection mechanism 220 is coupled with the cradle 20 and moves the cradle 20 longitudinally, in and out of the charging dock 40. The insertion/ejection mechanism 220 may comprise a lever/rod or the like or a plurality of separate components and/or levers/rods. In different embodiments, different numbers of levers and pivots may be used to provide for translation of a force applied to the user input 12 into movement of the cradle 20 into/out of the charging dock 40. For example, the user input 12 may comprise a switch or the like where the user input 12 may move along the surface of the charger 10 and a series of mechanical connections may translate this sliding motion into movement of the cradle 20 into/out of the charging dock 40. It is to be understood that the hearing device 30 is a small, light device, and the the charging dock 40 is also a small volume, such that only small input forces are needed at the user input 12 to cause the cradle 20 to move into/out of the charging dock 40.

In some embodiments, the insertion/ejection mechanism described in FIG. 2 may be used in reverse, e.g., the user may pull on the user input 12, rather than push the user input 12, to move the user input 12 in an opposite direction relative to an initial input to provide for insertion of the hearing device 30 in contrast to ejection of the hearing device 30. In other embodiments, two user inputs may be used, one to provide for insertion of the hearing device 30 and one to provide for ejection 30 of the hearing device 30.

In certain embodiments, the cradle 20 can be configured to insert the hearing device 30 to a charging position in the charger 10. For example, for wireless charging, the cradle 20 may move the hearing device 30 to a position in the charger 10 where a wireless induction coil 35 in the hearing device is aligned with a wireless induction coil 18 in the charger 10. In some embodiments, the charger 10 and/or the cradle 20 may comprise a holding mechanism for holding the hearing device 30 in the charging position in the charger 10. Similarly, after charging, the cradle 20 can be configured to eject the hearing device 30 from the charging position to an ejected position in the charger 10, where the hearing device 30 is accessible to the user for removal from the cradle 20 with little or no force and/or for grasping by a body/housing of the hearing device 30.

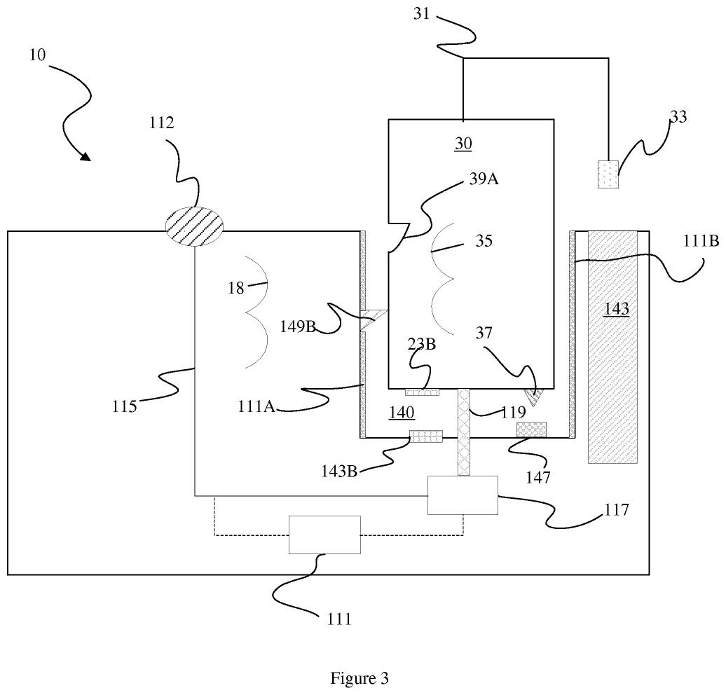

FIG. 3 illustrates a system for inserting a hearing device into and/or ejecting an hearing device from a charger, in accordance with an embodiment of the present disclosure.

In FIG. 3, a charger 10 comprises a charging dock 140. The charging dock 140 is configured to receive a hearing device 30. The hearing device 30 may comprise a communication component 31, for example an electronic cable, a sound tube or the like, that extends from the hearing device 30. The communication component 31 being configured in use to deliver sound from the hearing device 30 to a user's ear. In some embodiments, the hearing device 30 may comprise an in-ear component 33, such as an ear-tip, speaker and/or the like. Where the hearing device 30 is configured to be worn behind a user's ear (a BTE hearing device), the communication component 31 and/or the in-ear component 33, which in combination may comprise a sound delivery system 31, 33, may comprise a sound tube, ear hook, electric cable, ear-tip, speaker and/or the like that is configured to deliver sound from the hearing device into the user's ear.

In certain embodiments, the charging dock 140 is configured so that when the hearing device 30 is inserted into the charging dock it is positioned/held in a charging position in the charger 10. For example, for wireless charging, the hearing device 30 may be inserted by the insertion mechanism described herein to a position in the charger 10 where a wireless induction coil 35 in the hearing device is aligned with a wireless induction coil 18 in the charger 10. In some embodiments, the charger 10 and/or the charging dock 140 may comprise a holding mechanism for holding the hearing device 30 in the charging position in the charger 10. Similarly, after charging, insertion/ejection mechanism described herein is configured to eject the hearing device 30 from the charging position to an ejected/removing position in the charger 10, where the hearing device 30 is accessible to the user for removal from the charger 10 with little or no force and/or for grasping by a body/housing of the hearing device 30. In some embodiments, the hearing device 30 may be completely ejected from the charger 10, such that after ejection, the hearing device is completely outside of the charging dock 140 after ejection so that the complete hearing device 30 is accessible to the user.

While the following description describes inserting/holding the hearing device 30 in the charger 10 to provide for application of a charging current, it is to be understood that the insertion/holding techniques/systems can also apply to insertion/holding the hearing device 30 in the charger 30 in a charging position for wireless charging.

In some embodiments, the charging dock 140 comprises a docking terminal 147 that is configured to contact a charging terminal 37 of the hearing device 30. In some embodiments, the charging dock 140 is configured to accommodate the hearing device 30 such that when the hearing device 30 is inserted into the charging dock 140 the charging terminal 37 contacts the docking terminal 147 providing for electrical communication between the charging terminal 37 and the docking terminal 147.

In some embodiments of the present disclosure, the charging dock 140 is shaped to provide that the hearing device can only be inserted into the charging dock 140 in a single orientation, and this single orientation is configured to provide that the charging terminal 37 contacts the first docking terminal 147 when the hearing device 30 is inserted into the charging dock 140.

The charging dock 140 may be shaped to provide that there is space between an outer-surface 36 of the hearing device 30 and an inner-surface 22 of charging dock walls 111A and 111B. In such embodiments, gravity may provide the force for holding the charging terminal 37 in contact with the docking terminal 147. In some embodiments, magnets 143B and 23B (one of the magnets 143B and 23B may comprise a metallic compound instead of a magnet to provide for metallic coupling) may be used to hold the hearing device 30 in the charging dock 140 so that the charging terminal 37 and the docking terminal 147 are held in contact. In some embodiments, an inner-surface of the charging dock walls 111A and 111B and or the outer-surface 36 may comprise an elastic and/or grippy material that may hold the hearing device 30 in the charging dock 140 after insertion by a user.

In some embodiments, a latch system (nose 149B and notch 39A) may be used to hold the hearing device 30 in the charging dock 140 such that the docking terminal 147 and the first terminal 27A are held in contact. In some embodiments, the location of the nose 149B on the charging dock 140 and the notch 39A on the hearing device 30 may be reversed. In some embodiments of the present disclosure, the nose 149B may be retractable into a cavity (not shown) and may be spring loaded so that as the hearing device 30 is inserted in the charging dock 140, the nose 149B slides along an outer-surface of the hearing device 30 until it is inserted by a spring-type mechanism into the notch 39A. When the hearing device 30 is inserted into the charging dock 140, such that the notch 39A and the nose 29B align, the notch 39A and the nose 29B interact to hold the hearing device 30 in the charging dock 140, such that charging terminal 37 and the first terminal 147 are in contact.

In some embodiments, the charger 10 comprises a user input 112. The user input 112 may comprise an electrical switch or the like such that a user input may be electronically conveyed via electrical communicator 115 to an electrical actuator 117. The electrical actuator 117 may comprise a motor or the like and may interact with the hearing device 30 via an interaction element 119. As such, in some embodiments of the present disclosure, the electrical actuator 117 may receive communication of a user input to the user input 112 and generate motion of the hearing device into or out of the charging dock 140 via the interaction element 119.

In some embodiments, an end of the interaction element (not shown) may comprise a magnet, a grippy material, a latch and/or the like to provide for coupling of the interaction element 119 with the hearing device 30. In some embodiments, however, the hearing device 30 may be inserted into the charging dock 140 by the user pushing on the hearing device 30.

The interaction element 119 may in some embodiments comprise a screw-type mechanism, a geared mechanism, a combination of coupled substrates and/or the like that are configured to translate mechanical motion of the electrical actuator 117 into motion of the hearing device 30 into or out of the charging dock 140. In some embodiments of the present disclosure, the user input 112, the electrical communicator 115, the electrical actuator 117 and the interaction element 119 can provide insertion/ejection of the hearing device 30 into/from the charging dock 140.

The user input 112 may comprise an electrical switch or the like that can communicate with the electrical actuator 117 to either insert the hearing device 30 into the charger 10 or to eject the hearing device 30 from the charging dock 140. In some embodiments, the user input 112 may comprise two separate inputs one to control insertion of the hearing device 30 and one to control ejection of the hearing device 30. In some embodiments, the user input 112 may include a light or the like to identify the user input 112 to a user and/or to identify a status of the hearing device 30, e.g., whether the hearing device 30 is inserted, ejected, in contact with the charging terminals and/or whether the hearing device 30 is being charged or is fully charged.

In some embodiments, a controller 111 or the like that may control the operation of the electrical actuator 117. The controller 111 may comprise processing circuitry that controls the operation of the electrical actuator 117 based upon a user's input and/or a charging state of the hearing device 30, for example the controller 111 may control ejection of the hearing device 30 from the charger 10 when the hearing device 30 is fully charged.

The controller 111 may, in some embodiments, control the latch system such that when a user input is received by the controller 111 to insert the hearing device 30 in the charger 10, the controller 111 may control the latch system such that the nose 149B or the like, is activated to position and/or hold the hearing device 30 in the charging dock 140. Similarly, when a user input is received by the controller 111 to eject the hearing device 30 from the charging dock 140, the controller 111 may control the latch system such that the latch, nose 149B or the like, is retracted.

In some embodiments, an elastic element (not shown) such as a spring or the like, may be used to assist or provide for ejection of the hearing device 30 from the charging dock 140. For example, the controller 111 may control the nose 149B to retract from the notch 39A so that the elastic element may eject the hearing device 30 from the charging dock 140.

In some embodiments of the present disclosure, the charger 10 may comprise a protection device for the communication component 31 and/or the in-ear component 33. In some embodiments, the protection device may comprise a recess 143 into which the communication component 31 and/or the in-ear component 33 may be stored when the hearing device is in the charging dock 140 and/or a guard (not shown) that may prevent/make it difficult for the user of the hearing device 30 to access the communication component 31 and/or the in-ear component 33 when the hearing device 30 is in the charging dock 140.

In some embodiments, the charging dock 140 is configured to provide that after ejection in excess of 50% of the length of the hearing device 30 extends beyond walls 111A, 111B of the charging dock 140. Preferably, in some embodiments greater than 60%, 70% or 80% of the length of the hearing device 30 extends beyond the walls 111A, 111B of the charging dock 140 when the hearing device 30 is ejected from the charging dock 140 to provide for handling of the hearing device 30 by a user of the hearing device 30. It has been found that where a large surface area of the side of the hearing device 30 is accessible to a user, the user will grip the hearing device 30 by the sides of the hearing device 30 to insert/remove the hearing device 30 from the charging dock 140, rather than using the communication component 31.

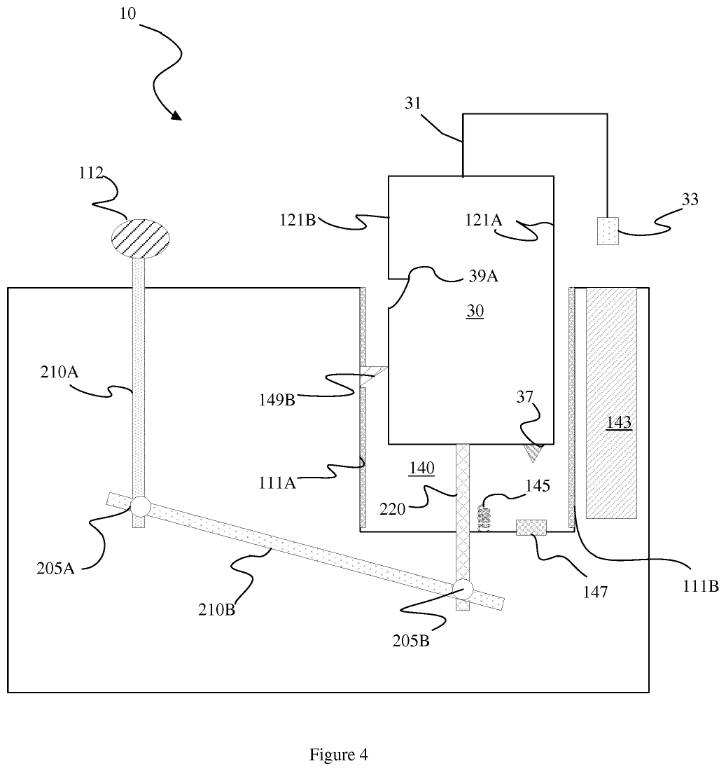

FIG. 4 illustrates a mechanically controlled system for inserting/ejecting an hearing device from a charging dock, in accordance with some embodiments of the present disclosure.

As described with respect to FIG. 3, some embodiments of the present disclosure provide a system for inserting/ejecting the hearing device 30 from the charging dock 140 using the user input 112. In some of these embodiments, the user input 112 may comprise a switch or a button configured to translate a user input force—e.g., a force that moves the switch or button—to a mechanical arrangement of levers.

For example, the user input 112 may be coupled with a first lever 210A that is in turn coupled to a second lever 210B. The first lever 201A may be coupled with a pivot point 205A, which may comprise an axle, a gear and/or the like, such that movement of the first lever 210A causes the second lever to pivot around the pivot point 205A. The coupling of the first and second levers 210A & B is configured to provide for translating a direction of the force applied by the user to the user input 112.

In some embodiments of the present disclosure, the second lever 210B is coupled with an insertion/ejection mechanism 220. The second lever 210B may be coupled with the insertion/ejection mechanism 220 and may pivot around a pivot point 205B, which may comprise an axle, a gear and/or the like. The coupling of the second levers 210B and the insertion/ejection mechanism 220 is configured to provide for translating a direction of the force acting on the second lever 210B such that the insertion/ejection mechanism 220 moves in a longitudinal direction in the charging dock 140.

The insertion/ejection mechanism 220 may comprise a lever/rod or the like or a plurality of separate components. In different embodiments, different numbers of levers and pivots may be used to provide for translation of a force applied to the user input 112 into movement of the hearing device 30 into/out of the charging dock 140. For example, the user input 112 may comprise a switch or the like where the user input 112 may move along the surface of the charger 10 and a series of mechanical connections may translate this sliding motion into movement of the insertion/ejection mechanism 220 into/out of the charging dock 140. It is to be understood that the hearing device 30 is a small, light device and as such the charging dock 140 comprises a small volume such that only small input forces are needed at the user input 112 to cause the hearing device 30 to move into/out of the charging dock 140.

In some embodiments, the insertion/ejection mechanism described in FIG. 4 may be used in reverse, e.g., the user may pull on the user input 112 rather than push the user input 112, move the user input 112 in an opposite direction relative to an initial input to provide for insertion of the hearing device 30 in contrast to ejection of the hearing device 30. In other embodiments, two user inputs may be used, one to provide for insertion of the hearing device 30 and one to provide for ejection of the hearing device 30.

In some embodiments, however, the hearing device 30 may be inserted into the charging dock 140 by the user pushing on the hearing device 30. Similarly, rather than using the user input 112 to eject the hearing device 30, a user may push the hearing device 30 downwards so that the latch system is released and a compliant element 145 may, as a result, provide for ejection of the hearing device 30 from the charging dock 140.

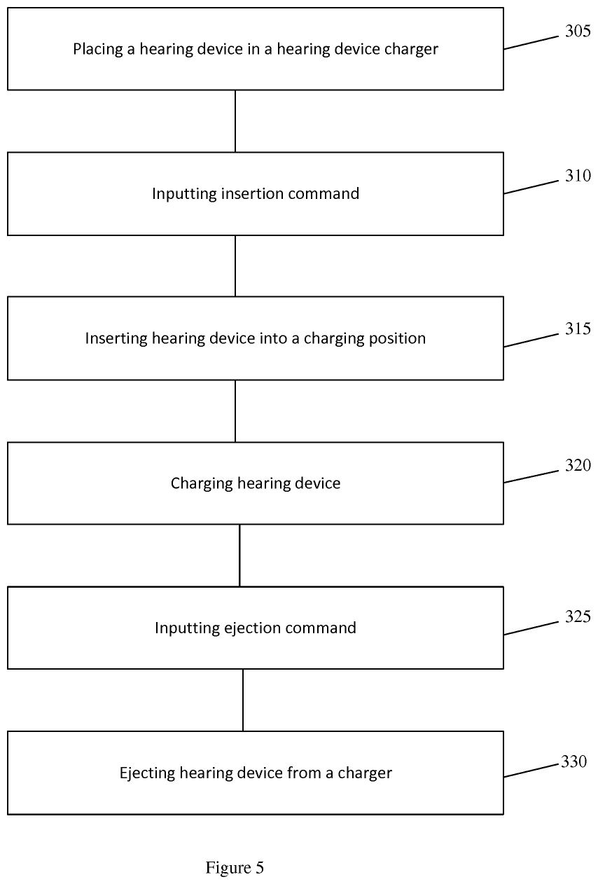

FIG. 5 is a flow-type illustration of a method for inserting and/or ejecting a hearing device into/out of a charger, in accordance with some embodiments of the present disclosure.

In step 305, a user places a hearing device in a charger. The user may place the hearing device in a cradle or in a charging dock of the charger. In some embodiments, the user may simply place the hearing device into the cradle/charging dock where the internal dimensions of the cradle charging dock are greater than that of the hearing device so that little or no force is required for the placement. In other embodiments, the user may need to apply a force to the hearing device so that the hearing device is held in the cradle/charging dock by friction with walls of the cradle/charging dock, a latch system and/or the like. Requiring application of force to the hearing device for placing in the charger has in general not been found to be detrimental to the hearing device.

In some embodiments, where the charger is a wireless charger, the charging dock may comprise sloping sides leading to a charging cavity shaped to receive the hearing device in a certain alignment, where the certain alignment aligns a receiving induction coil in the hearing device with a charging induction coil in the charger. In such embodiments, a user may simply ‘drop’ the hearing device in a top of the charging dock and let gravity ‘insert’ the hearing device in the charging cavity.

In step 310, the user inputs an insertion command into the charger. In some embodiments, this may comprise pushing a button, a switch or the like. In other embodiments, the user may push the hearing devise itself.

In step 315, the hearing device is inserted into a charging position in the charger. In mechanical systems, according to embodiments of the present disclosure, a force applied by a user to an input in step 310 is translated by the mechanical system into movement of the cradle or an insertion mechanism into a charging dock in the charger. In this way, the hearing device is inserted into a charging position in the charging dock. In some embodiments, a holding system may hold the hearing device in the charging dock. The holding mechanism may comprise walls of a docking cradle that may retract and clamp the hearing device such that it is held in the cradle and the cradle is moved to a charging position in the charger.

In some embodiments, a user's input in step 310 is electronically communicated to an actuator and the actuator may provide for insertion of the hearing device into the charger. The electronic communication with the actuator may be made via processing circuitry that controls the actuator. The actuator may comprise an electrical motor, a mechanical actuator configured to convert an electronic signal to mechanical motion, a controlled compliant coupling, a hydraulic actuator and/or the like.

In some embodiments, the charger may not require steps 310 or 315 as the user may insert the hearing device directly in the charger into a charging position. Or as described above, where the charger comprises a wireless charger, gravity may insert the hearing device in the charger. In yet other embodiments, the charger may comprise a box like structure and the lid may serve as a user input, such that closing the lid of the charging box either causes an electrical communication to insert the hearing device in the charger or provides an input force that drives a mechanical system to insert the hearing device into the charger.

In step 320, the charger chargers the hearing device, where charging may be via electrical connections or wireless charging. Indicators may be provided that provide optical signals regarding the charging status of the hearing device, e.g., charging, charged, and/or the like and/or the status of the hearing device in the charger, e.g., inserted, in charging position, ejected and/or the like.

In step 325, a user inputs an ejection command. The ejection command may be made by pushing a button, operating a switching mechanism, pushing on the hearing device in the charger and/or the like. In some embodiments where the charger comprises a box like structure with a lid, the user input for ejecting the hearing device may comprise opening the lid of the box.

In step 330 the hearing device is ejected from the charger. In embodiments where the user ejection command is communicated electronically an electro-to-mechanical actuator may be used to eject the hearing device from the charger. In embodiments, where the user ejection command is communicated via mechanical means, the force of the user input may be translated via a mechanical system to a force the hearing device causing it to eject from the charger. For example, kinetic motion of a button, switch, a lid of the charger and/or the like may be translated via a mechanical system to a force on the hearing device in direction such that the hearing device is ejected from the charger. In some embodiments, where the hearing device is inserted in a charging cradle, the force may be applied to the charging cradle to eject the cradle and the hearing device from the charger.

In embodiments, where the charger includes a holding device to hold the hearing device in the charger, the user command may also be communicated to the holding mechanism to release the hearing device. In some embodiments, ejection of the hearing device from the charger comprises moving the hearing device and/or a charging cradle in a charging dock such that at least 60%, 70% or preferably 80% of a length of the hearing device is accessible to a user above the walls of the charging dock. In some embodiments, the whole hearing device may be ejected from the charging dock such that it lays on top of the ejection mechanism and can easily be picked up by a user.

In some embodiments, the ejection mechanism is configured to provide that at least 0.5 centimetres. 0.75 centimetres or in excess of 1.0 centimetres in length of the hearing device housing extends outside of the hearing device holder/charging dock when the hearing device is ejected from the charger.

While the principles of the disclosure have been described above in connection with specific apparatuses and methods, it is to be clearly understood that this description is made only by way of example and not as limitation on the scope of the invention.

1. A hearing device charger configured to charge a rechargeable hearing device, the hearing device charger comprising:
a power supply for supplying a charging current to a rechargeable hearing device;
a charging dock configured to accommodate at least a portion of the rechargeable hearing device;
wherein the hearing device charger comprises:
a user control configured to receive an input from a user to either insert the hearing device into a charging position in the charging dock or eject the hearing device to a removing position in the charging dock; and
an insertion/ejection mechanism configured to move the hearing device between the charging position and the removing position,
wherein the insertion/ejection mechanism comprises an electrical actuator in electrical communication with the user control configured to move the hearing device between the charging position and the removing position.

2. The hearing device charger according to claim 1, wherein the user control comprises one of a switch, a button, a lever or a lid that is moveably coupled with the hearing device charger.

3. The hearing device charger according to claim 3, wherein the insertion/ejection mechanism comprises a mechanical insertion/ejection mechanism comprising a plurality of levers in mechanical communication with the user control and configured to mechanically translate an input force applied by the user to the user control to an insertion/ejection force applied to the hearing device.

4. The hearing device charger according to claim 3, wherein the mechanical insertion/ejection mechanism comprises one or more gears.

5. (canceled)

6. The hearing device charger according to claim 4, wherein the electrical actuator comprises one of an electrical motor and a hydraulic pump.

7. (canceled)

8. The hearing device charger according to claim 2, wherein the insertion/injection mechanism further comprises a cradle configured to hold the hearing device.

9. The hearing device charger according to claim 8, wherein the cradle comprises moveable side walls that move inward to squeeze against the hearing device housing during insertion and/or move outwards to release the hearing device during ejection.

10. The hearing device charger according to claim 1, wherein:
the rechargeable battery comprises battery terminals for charging the rechargeable battery;
the charging dock comprises charging terminals electrically connected with the power supply and configured to provide an electrical connection with the battery terminals; and
the charging dock comprises a holding mechanism for holding the hearing device in the charging position, such that in the charging position the battery terminals contact the charging terminals.

11. The hearing device charger of claim 10, wherein the holding mechanism comprises at least one of a latch system, an elastic element and a magnet.

12. The hearing device charger according to claim 10, wherein the holding mechanism further comprises a release mechanism for releasing the holding mechanisms when the hearing device is moved from the charging position to the removing position.

13. The hearing device charger according to claim 12, wherein the removing position at least 0.5 centimeters, 0.75 centimeters or in excess of 1.0 centimeters in length of the hearing device housing extends outside of the hearing device holder.

14. The hearing device charger according to claim 1, wherein in the removing position less than 30% of a longitudinal length of the hearing device body is disposed within the hearing device holder.

15. The hearing device charger according to claim 1, further comprising a guard section configured to receive at least a portion of the sound delivery mechanism.

16. The hearing device charger according to claim 1, further comprising:
an indicator light configured to indicate a status of the hearing device.

17. The hearing device charger according to claim 10, wherein:
the hearing device charger comprises a charging induction coil;
the hearing device comprises a hearing device induction coil; and
in the charging position, the charging induction coil and the hearing device induction coil are aligned for wireless charging of the hearing device.

18. A method for inserting/injecting a hearing device into/out of a charging dock of a hearing device charger, comprising:
receiving a user control from a user input;
communicating the user input to an actuator; and
activating the actuator to move the hearing device between a charging position and a removing position in the charging dock, wherein the charging position comprises a position configured for charging the hearing device and the removing position comprises a position configured for removal of the hearing device by the user.

19. The method of claim 18, wherein in the removing position greater than 70% or preferably greater than 80% of a longitudinal length of the hearing device extends outside of the charging dock.

20. The method of claim 19, wherein in the removing position the hearing device is completely ejected from the charging dock.

21. The method of claim 18, wherein:
the user control comprises one of a switch, a button, an input lever and a lid of the hearing device charger that is moveably coupled with the hearing device charger, and wherein the method further comprises
communicating the user input to the actuator and using the actuator to move the hearing device between the charging position and the removing position in the charging dock comprises mechanically communicating a force applied by the user to the user control to the hearing device to move the heating device between the charging position and the removing position.

22. The method according to claim 20, wherein:
communicating the user input to the actuator comprises electronically communicating the user input to the actuator; and
activating the actuator to move the heating device between the charging position and the removing position in the charging dock comprises controlling the actuator to move the hearing device between the charging position and the removing position.
